(19) United States
(12) Patent Application Publication
(10) Pub. No.: US 2014/0368879 A1
(43) Pub. Date: Dec. 18, 2014

(54) PRINTING APPARATUS, PRINTING SYSTEM, CONTROL METHOD FOR PRINTING APPARATUS, AND STORAGE MEDIUM

(71) Applicant: CANON KABUSHIKI KAISHA, Tokyo (JP)

(72) Inventor: Yoshiji Kanamoto, Tokyo (JP)

(73) Assignee: CANNON KABUSHIKI KAISHA, Tokyo (JP)

(21) Appl. No.: 14/360,912

(22) PCT Filed: Nov. 15, 2012
(86) PCT No.: PCT/JP2012/007335

§ 371 Date: May 27, 2014

(30) Foreign Application Priority Data
Nov. 30, 2011 (JP) 2011-261837

(51) Int. Cl. G06K 15/00

(52) U.S. Cl. CPC G06K 15/4065
USPC 358/1.15

(57) ABSTRACT

If an attribute value of a sheet to be used in print processing and sheet processing are set in a print job, a sheet satisfying both an allowable range of the sheet to be used in the printing processing and a condition of a sheet applicable to the sheet processing is searched.

### TECHNICAL FIELD

The present invention relates to a printing apparatus, a printing system, a control method for the printing apparatus, and a storage medium.

### BACKGROUND ART

Conventionally, a printing apparatus such as a multi functional peripheral (MFP) can execute print processing on a sheet based on a print job. The printing apparatus generally includes a plurality of sheet feeding cassettes. When executing the print processing, the printing apparatus needs to search for a sheet feeding cassette to be used for printing from the plurality of sheet feeding cassettes. Patent literature 1 (Japanese Patent Application Laid-Open No. 2005-059974) discusses a method for searching for a sheet feeding cassette to be used for printing from a plurality of sheet feeding cassettes based on an attribute value such as name and a size of a sheet.

In addition, for example, when a sheet size is designated in a print job, a sheet having the designated size is not always present. Accordingly, a method for setting an allowable range during the search is also known. More particularly, for example, when a main scanning direction size of 290 mm is designated as an attribute value of a sheet to be used for printing, the method searches for a sheet to be used for printing with a range of 280 mm to 300 mm as an allowable range.

However, the patent literature 1 considers the attribute value of the sheet designated in the print job, and does not consider any sheet processing (e.g., folding processing and case binding) which is executed with respect to the sheet having undergone print processing. As for the sheet processing, there is a condition of a sheet capable of undergoing the sheet processing. According to the patent literature 1, therefore, even if a sheet to be used for printing is searched from a plurality of sheets, there may be a case where the sheet processing cannot be executed on the sheet designated in the print job.

### CITATION LIST

### Patent Literature

PTL 1: Japanese Patent Application Laid-Open No. 2005-059974

### SUMMARY OF INVENTION

The present invention is directed to a search for a sheet to be used for printing based on both an attribute value of a sheet designated in a print job and sheet processing designated in the print job.

According to an aspect of the present invention, a printing apparatus includes a first storage unit configured to store a plurality of pieces of sheet information indicating a sheet and including an attribute value of the sheet, a second storage unit configured to store an allowable range used for searching a sheet to be used in print processing using the attribute value, a third storage unit configured to store a condition of a sheet applicable to sheet processing which is executed with respect to a sheet on which the print processing is executed, a searching unit configured to search for specific sheet information from the first storage unit based on the allowable range and the condition of the sheet applicable to the sheet processing in a case where an attribute value of a sheet to be used in the print processing and sheet processing are set in a print job, and a printing unit configured to execute print processing on a sheet indicated by the specific sheet information found by the searching unit.

Further features and aspects of the present invention will become apparent from the following detailed description of exemplary embodiments with reference to the attached drawings.

### BRIEF DESCRIPTION OF DRAWINGS

The accompanying drawings, which are incorporated in and constitute a part of the specification, illustrate exemplary embodiments, features, and aspects of the invention and, together with the description, serve to explain the principles of the invention.

FIG. 1 is a diagram of a printing system according to an exemplary embodiment of the present invention.

FIG. 2 is a diagram of a configuration of a printing apparatus according to the exemplary embodiment.

FIG. 3 is a diagram of a configuration of a personal computer (PC) according to the exemplary embodiment.

FIG. 4 is a diagram of a sheet management table according to the exemplary embodiment.

FIG. 5 is a diagram of an allowable range management table according to the exemplary embodiment.

FIG. 6 is a diagram of a particular example of a search for a sheet according to the exemplary embodiment.

FIG. 7 is a diagram of a constraint information table according to the exemplary embodiment.

FIG. 8 is a diagram of a particular example of a search for a sheet according to the exemplary embodiment.

FIG. 9 is a flowchart illustrating a search for a sheet according to the exemplary embodiment.

FIG. 10 is a diagram of a screen relating to error processing according to the exemplary embodiment.

### DESCRIPTION OF EMBODIMENTS

Various exemplary embodiments, features, and aspects of the invention will be described in detail below with reference to the drawings.

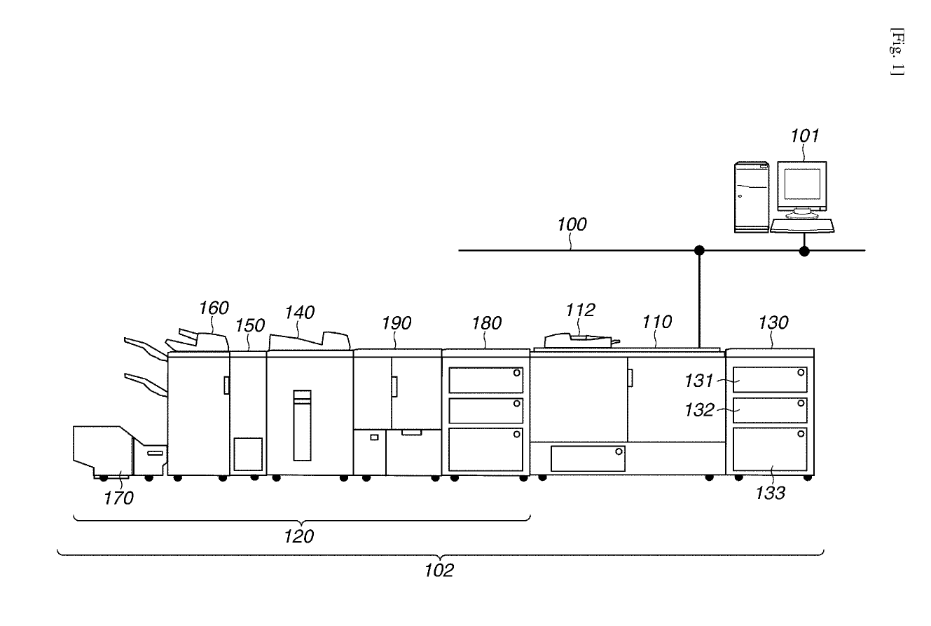

FIG. 1 is a diagram of a printing system according to an exemplary embodiment of the present invention. A printing apparatus 102 includes a plurality of apparatuses each having a different function and can execute print processing with respect to a sheet and various types of sheet processing with respect to the sheet having undergone the print processing. A personal computer (PC) 101 inputs a print job to the printing apparatus 102. The printing apparatus 102 and the PC 101 are communicably connected with each other via a network 100.

Next, each of the apparatuses included in the printing apparatus 102 is described.

A printer unit 110 executes print processing to a sheet based on print image data generated by rasterizing the input print job. A configuration of the printer unit 110 and an operation principle of the print processing are described below.

A rotating polygon mirror (e.g., a polygonal mirror) causes light such as a laser beam modulated according to print image data to enter, so that the light is applied to a photo-sensitive drum via a reflection mirror as reflected scanning light. A latent image formed on the photosensitive drum by the laser beam is developed with toner, and a toner image is transferred to a sheet on a transfer drum. Such a series of image forming processes is sequentially executed with respect to toners of yellow (Y), magenta (M), cyan (C), and black (K), thus, a full color image is formed. In addition to these four colors, a toner referred to as a special color and a transparent toner may be transferred. The sheet having the image on the transfer drum is conveyed to a fixing device. The fixing device includes a combination of a roller and a belt, and a built-in heat source such as a halogen heater. The fixing device fuses and fixes the toner on the sheet having the transferred toner image with heat and pressure.

The printer unit 110 includes an operation unit 111 (not illustrated). The operation unit 111 provides an interface used when a user performs various settings and an operation on the printing apparatus 102. The printer unit 110 also includes a scanner 112.

A paper feeder 130 is detachably connected to the printer unit 110. The paper feeder 130 includes a plurality of sheet feeding cassettes 131, 132, and 133, and can store a large amount of sheets. The paper feeder 130 enables the printing apparatus 102 to execute a large volume of print processing. In FIG. 1, the printing apparatus 102 includes one paper feeder 130. However, a plurality of paper feeders may be connected as necessary.

A stacker 140 stacks a printed sheet therein. In FIG. 1, the printing apparatus 102 includes one stacker 140. However, a plurality of stackers may be included as necessary.

A folding device 150 executes various types of folding processing, such as middle-folding, Z-folding, and three-folding to a printed sheet.

A saddle stitch bookbinding device 160 includes various units for performing stapling and bookbinding processing on printed sheets to produce a bookbinding product. The bookbinding processing includes saddle binding, saddle folding, punching, shift discharge processing, and the like.

A cutting device 170 cuts a portion corresponding to an edge portion of a bookbinding product provided by saddle binding by the saddle stitch bookbinding device 160 to smoothen the edge portion.

An inserter 180 inserts a sheet stored thereinside between sheets fed from the printer unit 110 at an appropriate timing based on a setting. The inserter 180 can insert a sheet, which is not required printing, between printed sheets.

A case binding device 190 glues a front cover to a bundle of sheets printed by the printer unit 110 or to a bundle of sheets including sheets inserted by the inserter 180, and outputs a case bound product. The case binding device 190 can also execute pad bookbinding processing which perform glue binding on sheets without a front cover.

According to the present exemplary embodiment, it is assumed that each of the apparatuses disposed on a left side of the printer unit 110 illustrated in FIG. 1 is generically referred to as a sheet processing apparatus 120.

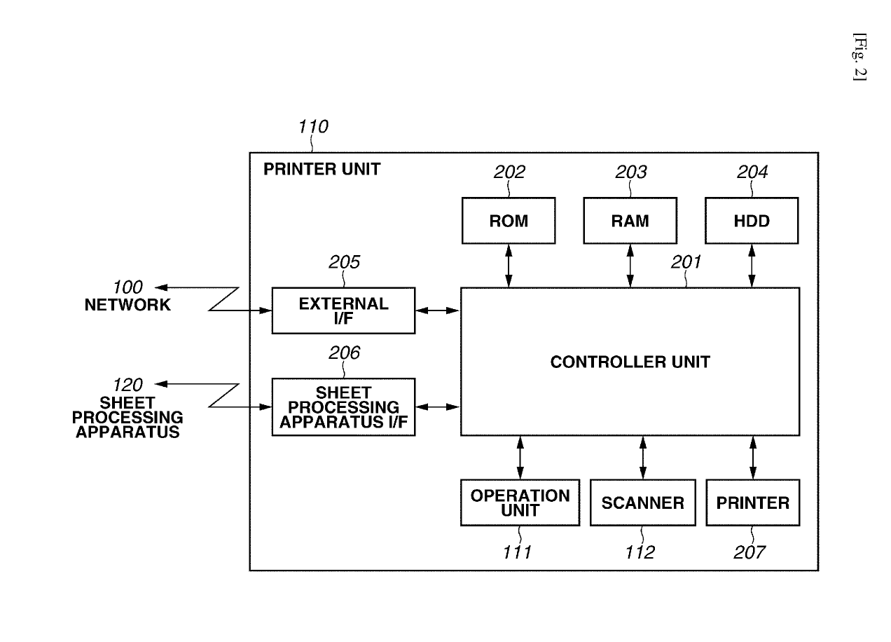

Next, an internal configuration of the printer unit 110 of the printing apparatus 102 is described with reference to FIG. 2.

A controller unit 201 including a central processing unit (CPU) controls the entire processing of each of apparatuses and devices included in the printing apparatus 102 by reading a control program stored in a read only memory (ROM) 202 or a hard disk drive (HDD) 204. The ROM 202 stores, for example, a program for operating the controller unit 201. A random access memory (RAM) 203 is used as a temporary storage area such as a main memory and a work area of the controller unit 201. As similar to the ROM 202, the HDD 204 stores a program for operating the controller unit 201. The ROM 202 and the HDD 204 also store display control programs for displaying various user interface (UI) screens on a display unit of the operation unit 111. The HDD 204 also stores a sheet management table 400, an allowable range management table 500, and a constraint information table 700 which are described below.

An external interface (I/F) 205 receives a print job from the PC 101 via the network 100, and communicates with an external device. Print jobs received from the PC 101 are stored in the HDD 204 or the ROM 202, and are sequentially executed by the controller unit 201.

A printer 207 executes print processing based on a print job received by the external I/F 205, or image data generated by reading an original document by the scanner 112.

A sheet processing apparatus I/F 206 communicates with the sheet processing apparatus 120. The controller unit 201 of the printer unit 110 controls an operation of the sheet processing apparatus 120 via the sheet processing apparatus I/F 206.

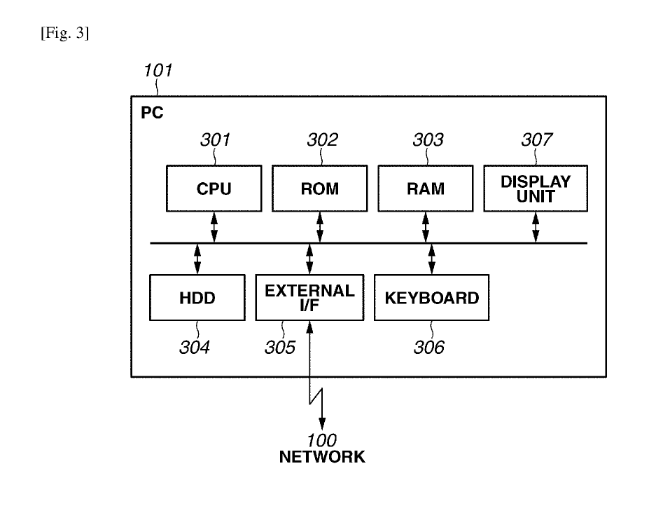

Next, an internal configuration of the PC 101 is described with reference to FIG. 3.

A CPU 301 controls the PC 101 by reading a control program stored in a ROM 302 or a HDD 304. The ROM 302 stores a program for operating the CPU 301. A RAM 303 is used as a temporary storage area such as a main memory and a work area of the CPU 301. As similar to the ROM 302, the HDD 304 stores a program for operating the CPU 301.

An external I/F 305 connects the PC 101 and the network 100. The PC 101 can communicate with the printing apparatus 102 via the network 100. A keyboard 306 is used to input information to the PC 101. A display unit 307 displays various screens thereon.

The printing apparatus 102 can be controlled from the PC 101 if a printer driver is installed in the PC 101.

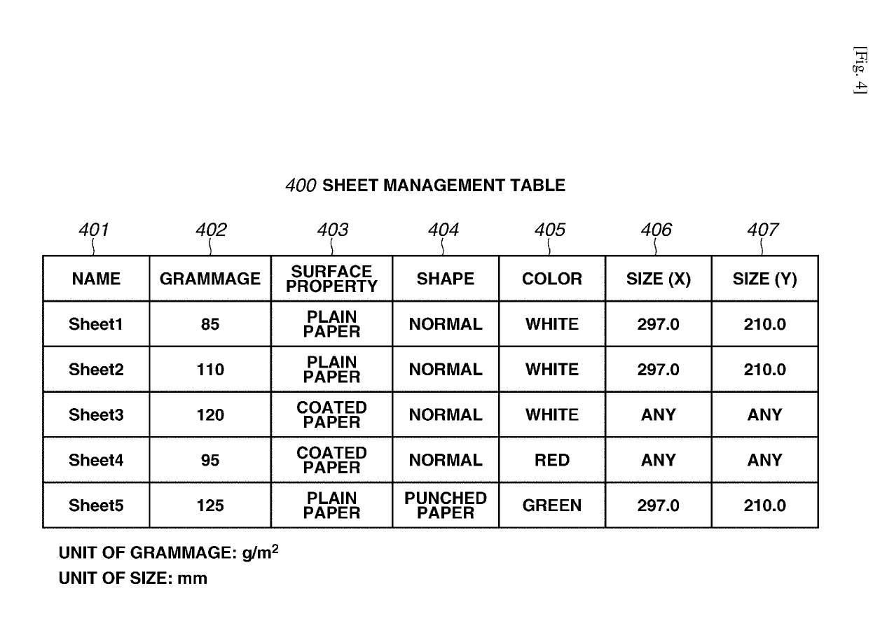

According to the present exemplary embodiment, the printing apparatus 102 stores information (hereinafter referred to as sheet information) indicating a sheet to be used for printing in the HDD 204 as the sheet management table 400. The sheet management table 400 is described with reference to FIG. 4.

FIG. 4 illustrates an example of the sheet management table 400 in which five types of sheet information are stored. The sheet information stored in the sheet management table 400 is not limited to the five types illustrated in FIG. 4. New sheet information can be stored, or the stored sheet information can be deleted by an input from a user via the operation unit 111 of the printing apparatus 102 or the keyboard 306 of the PC 101.

A name 401 is an attribute indicating an arbitrary name provided to sheet information when the sheet information is registered in the sheet management table 400. The name can be determined by the printing apparatus 102 based on a registration date. Alternatively, a user can set an arbitrary name and store in the sheet management table 400.

A grammage 402 is an attribute indicating a weight per unit area of a sheet. The grammage 402 is generally expressed in grams per square meter. A surface property 403 is an attribute classified by a surface property of a sheet. In the surface property 403, coated paper represents a sheet capable of providing a higher-quality printing result than normal paper by applying a coating on a surface thereof. A shape 404 is an attribute used to distinguish a processed sheet or a special sheet in need of processing from other sheets. In the shape 404, punched paper represents a sheet having a punched hole. A color 405 is an attribute used to identify color of a sheet.

A size (X) 406 is an attribute indicating a length in a main scanning direction, that is, a length in a direction perpendicular to a conveyance direction among sizes of a sheet. Similarly, a size (Y) 407 is an attribute indicating a length in a sub-scanning direction, that is, a length in a direction parallel to the conveyance direction among sizes of a sheet.

According to the present exemplary embodiment, these various attributes are used to manage the sheet information. When a sheet to be used for printing is designated in a print job, these attributes are used for sheet designation. More particularly, in the sheet management table 400, when “grammage” and “85 g/m²” are respectively designated as an attribute and an attribute value of a sheet to be used for printing, “Sheet1” is selected as the sheet to be used for printing.

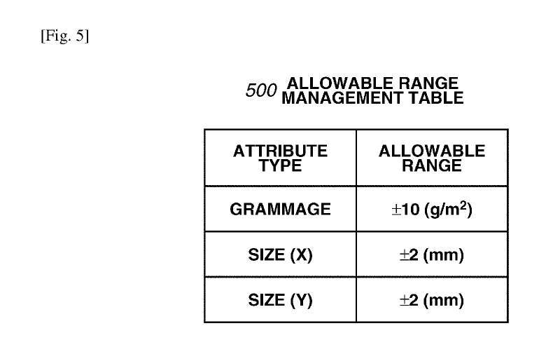

On the other hand, for example, if “grammage” and “90 g/m²” are respectively designated as an attribute and an attribute value of a sheet to be used for printing, there is no corresponding sheet information included in the sheet management table 400. Thus, a print job is not executed. However, as for an attribute such as the “grammage” having continuous attribute values, there is a case where a practical issue may not occur when the attribute value is close to a designated value. More particularly, when “Sheet1” having a “grammage” of “85 g/m²” or “Sheet4” having a “grammage” of “95 g/m²” is used for printing, there is a case where a practical issue may not occur. Such a point is considered in the present exemplary embodiment, and an allowable range as illustrated in FIG. 5 is set with respect to an attribute such as “grammage” and “size” having continuous attribute values.

In the sheet management table 400 according to the present exemplary embodiment, there is an attribute having an attribute value of “ANY”. The attribute value of “ANY” is a special attribute value indicating a state that an explicit attribute value is not stored. When a sheet to be used for printing is searched, a sheet having an attribute value of “ANY” is always searched as a candidate sheet to be used for printing.

According to the present exemplary embodiment, the sheet management table 400 manages all the sheet information pieces handled by the printing apparatus 102. A user can set any of the sheet information managed by the sheet management table 400 with respect to each of the sheet feeding cassettes included in the printing apparatus 102 via a setting screen (not illustrated). Thus, the printing apparatus 102 can determine what sheet is stored in which sheet cassette.

FIG. 5 illustrates an allowable range management table 500 for setting an allowable range of an attribute value of a sheet to be used for printing. The allowable range management table 500 is stored in the HDD 204 as similar to the sheet management table 400.

According to the allowable range management table 500, an attribute “grammage” has an allowable range of plus or minus 10 g/m². In other words, when an attribute of “grammage” and an attribute value of “100 g/m²” are designated as a sheet to be used for printing in a print job, sheets having the “grammage” ranging from “90 g/m² to 110 g/m²” become search targets. As for each of “SIZE (X)” and “SIZE (Y)”, an allowable range of an attribute value is set as similar to the “grammage”. The allowable range managed by the allowable range management table 500 can be set in the printing apparatus 102 in advance, or can be set by a user by setting an optional value.

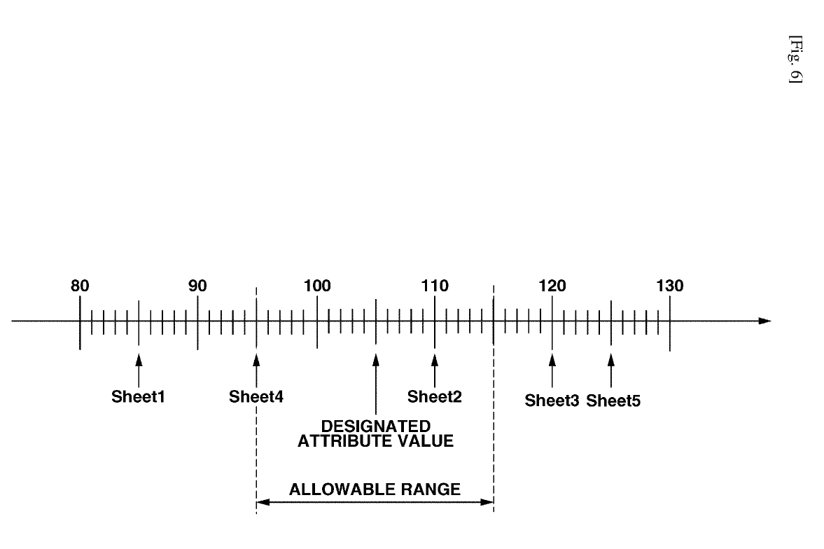

FIG. 6 illustrates a relationship between the sheet management table 400 illustrated in FIG. 4 and the allowable range management table 500 illustrated in FIG. 5 using a number line. In FIG. 6, the number line indicates an attribute value of grammage, and each of Sheet1 through Sheet5 is indicated on a position corresponding to the attribute value set in the sheet management table 400. It is assumed that an attribute value of the grammage designated in a print job is 105 g/m². In this case, if a sheet having a grammage of 105 g/m² is stored in the sheet management table 400, the sheet can be selected for printing. However, such a sheet is not stored in the sheet management table 400. Accordingly, a sheet having an attribute value of the grammage close to 105 g/m² is selected based on the allowable range management table 500.

According to the allowable range management table 500, the allowable range for the attribute value of the attribute is plus or minus 10 g/m². Therefore, the attribute value of the grammage to be selected is 95 g/m² to 115 g/m². This range is illustrated as an allowable range on the number line in FIG. 6. According to the number line illustrated in FIG. 6, Sheet2 and Sheet4 are provided within the range in which the attribute value of the grammage is 95 g/m² to 115 g/m².

Therefore, a plurality of sheets is provided within the allowable range in FIG. 6. According to the present exemplary embodiment, it is assumed that a sheet having an attribute value closer to an attribute value designated by a print job is selected and determined as a sheet to be used for printing from a plurality of sheets. In FIG. 6, since the attribute value of the grammage designated in the print job is 105 g/m², the Sheet2 having the grammage of 110 g/m² is selected as a sheet to be used for printing. A method for determining a sheet to be used for printing from a plurality of sheets is not limited to the above method. For example, a sheet may be selected by a user.

As described above, the use of the allowable range management table 500 enables printing to be executed using a similar sheet even if there is no sheet having the attribute value designated in a print job, thus the convenience of users can be enhanced. However, a sheet to be used for printing needs to be determined by considering not only the attribute value designated in a print job, but also sheet processing to be executed on a printed sheet. Such consideration is needed since a sheet applicable to sheet processing may be constrained depending on contents of the sheet processing. The constraint on the sheet is described in detail below.

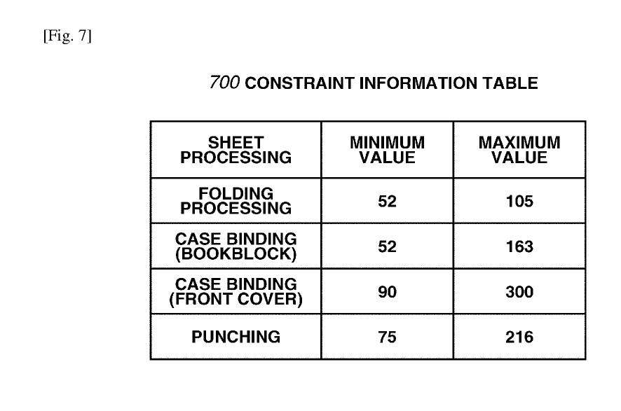

FIG. 7 is a diagram of a constraint information table 700 storing a combination of sheet processing executable by the printing apparatus 102 and grammage of a sheet applicable to the sheet processing. According to the constraint information table 700, if folding processing is executed as sheet processing, a folding processing executable sheet is constrained to have a grammage of 52 g/m² to 105 g/m² which is set as constraint information. Further, the constraint information table 700 includes settings of constraint information of a sheet usable as a bookblock of case binding, constraint information of a sheet usable as a front cover of case binding, and constraint information of a sheet capable of undergoing punching. The constraint information stored in the constraint information table 700 may be set in the printing apparatus 102 in advance, or a user may set arbitrary constraint information.

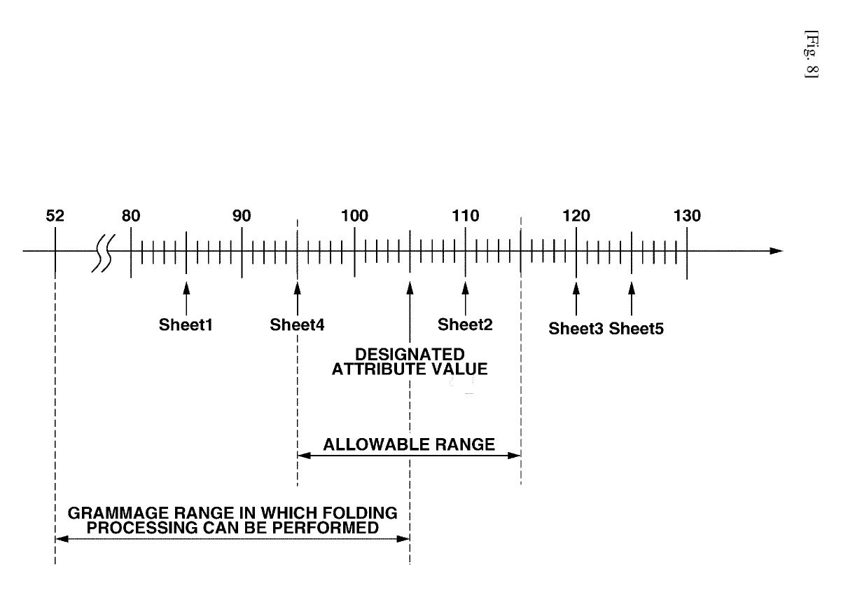

FIG. 8 is a diagram of a relationship among the sheet management table 400 illustrated in FIG. 4, the allowable range management table 500 illustrated in FIG. 5, and the constraint information table 700 illustrated in FIG. 7 using a number line as similar to that illustrated in FIG. 6. The diagram illustrated in FIG. 8 includes folding processing which is set as sheet processing in a print job, unlike FIG. 6.

If folding processing is not set in a print job, that is, in FIG. 6, sheets within the allowable range of the attribute value designated in the print job are Sheet2 and Sheet4, and the Sheet2 having the attribute value closer to the attribute value designated in the print job is selected as a sheet to be used for printing. However, if the Sheet2 closer to the attribute value designated in the print job is selected as similar to FIG. 6, and then the folding processing is executed, there is a possibility of error occurring such as jam since the Sheet2 is not within a grammage range in which the folding processing can be performed. Accordingly, in an example illustrated in FIG. 8, when the folding processing is set as the sheet processing in the print job, the Sheet4 applicable to the folding processing is selected as a sheet to be used for printing instead of the Sheet2 closer to the attribute value designated in the print job.

Thus, according to the present exemplary embodiment, if sheet processing is set in a print job, an appropriate sheet can be selected by considering not only an allowable range provided in the allowable range management table 500, but also constraint information of a sheet usable in the sheet processing.

In the example of FIG. 8, the folding processing is designated as the sheet processing, and the constraint information of the sheet with respect to the sheet processing is a grammage of 52 g/m² to 105 g/m². However, there may cases where a plurality of types of sheet processing is designated in a print job. For example, if folding processing and punching are designated as a plurality of types of the sheet processing, constraint information of a sheet will be a grammage of 75 g/m² to 105 g/m².

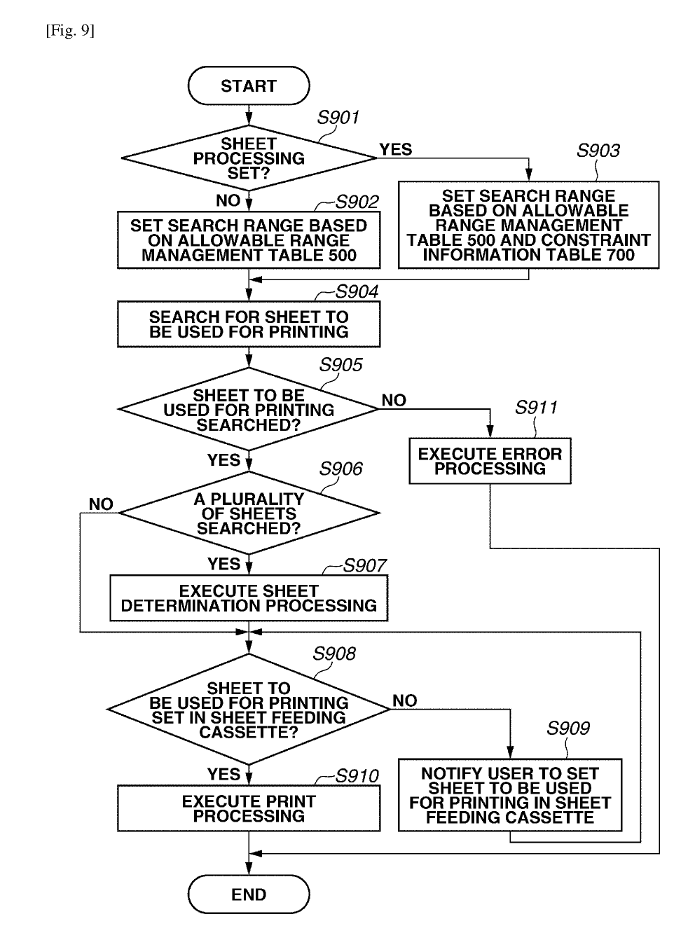

FIG. 9 is a flowchart illustrating processing for searching for a specific sheet to be used in printing according to the present exemplary embodiment. Each of steps S901 through S911 illustrated in FIG. 9 is processed when the controller unit 201 (CPU) of the printing apparatus 102 loads a program stored in a memory such as the ROM 202 into the RAM 203 and executes the program.

In step S901, when the printing apparatus 102 receives a print job including a designated attribute and a designated attribute value of a sheet to be used for printing from the PC 101, the controller unit 201 determines whether sheet processing is set in the received print job. The sheet processing according to the present exemplary embodiment is not limited to the folding processing, case binding, and punching described with reference to FIG. 7. The sheet processing may include stapling, for example. If the controller unit 201 determines that the sheet processing is not set in the received print job (NO in step S901), the operation proceeds to step S902. On the other hand, if the controller unit 201 determines that the sheet processing is set in the received print job (YES in step S901), the operation proceeds to step S903.

In step S902, the controller unit 201 specifies the attribute of the sheet designated in the print job, and extracts an allowable range of the attribute from the allowable range management table 500. The controller unit 201 sets a search range of the sheet to be used for printing based on the extracted allowable range and the attribute value designated in the print job.

More particularly, if the attribute and the attribute value of the sheet to be used for printing designated in the print job are “grammage 105 g/m²”, the search range of the sheet will be “grammage 95 g/m² to 115 g/m²”. If the attribute and the attribute value of the sheet to be used for printing designated in the print job are “SIZE (X) 250 mm”, the search range of the sheet will be “SIZE (X) 248 mm to 252 mm”.

The attribute value of the sheet is not limited to grammage and size. For example, a color value parameter indicating color may be used. In addition to the grammage and size, an allowable range corresponding to other attributes such as a color value parameter can be managed as necessary by the allowable range management table 500.

In step S903, the controller unit 201 specifies the attribute of the sheet designated in the print job, and extracts the allowable range of the attribute from the allowable range management table 500. Moreover, in step S903, since the sheet processing is set in the print job, the controller unit 201 specifies the sheet processing set in the print job, and extracts constraint information of the specified sheet processing from the constraint information table 700. Accordingly, the controller unit 201 sets the search range of the sheet to be used for printing based on the attribute value designated in the print job, the allowable range extracted from the allowable range management table 500, and the constraint information extracted from the constraint information table 700.

More particular, if the attribute and the attribute value of the sheet to be used for printing designated by the print job are “grammage 105 g/m²”, and folding processing is designated as the sheet processing, the search range of the sheet will be “grammage 95 g/m² to 105 g/m²”. In step S903, since the constraint information table 700 is also considered, there is a case where the search range of the sheet differs from that set in step S902. In the constraint information table 700, the constraint information relating to the grammage is managed. However, the constraint information is not limited thereto. For example, constraint information relating to other attributes such a size and a color value parameter may be managed.

In step S904, the controller unit 201 searches for a sheet to be used for printing from the sheet management table 400 based on the search range set in step S902 or step S903.

In step S905, the controller unit 201 determines whether one or more types of sheets are searched. If the controller unit 201 determines that one or more types of sheets are searched (YES in step S905), the operation proceeds to step S906.

On the other hand, if controller unit 201 determines that one or more types of sheets are not searched (NO in step S905), the operation proceeds to step S911. In step S911, the controller unit 201 executes error processing. The error processing in step S911 is described in detail below.

In step S906, the controller unit 201 determines whether the number of types of sheets searched in step S904 is plural. If the controller unit 201 determines that a plurality of types of sheets is not found in step S904, in other words, one type of sheet is searched (NO in step S906), the sheet searched in step S904 is determined as the sheet to be used for printing, and then operation proceeds to step S908. On the other hand, if the controller unit 201 determines that a plurality of types of sheets is found in step 904 (YES in step S906), the operation proceeds to step S907.

In step S907, the controller unit 201 executes sheet determination processing for determining the sheet to be used for printing from the plurality of types of the sheets found in step S904. According to the present exemplary embodiment, it is assumed that the sheet determination processing determines a sheet having an attribute value closer to the attribute value designated in the print job as the sheet to be used for printing. However, the sheet determination processing is not limited thereto. For example, a user may select a desired sheet from the plurality of types of sheets found in step S904, and the sheet selected by the user may be determined as the sheet to be used for printing. Then, the operation proceeds to step S908.

When the sheet to be used for printing is determined, in step S908, the controller unit 201 determines whether the sheet is set in a sheet feeding cassette. If the controller unit 201 determines that the sheet to be used for printing is set in the sheet cassette (YES in step S908), then in step S910, the print processing is executed using the sheet.

On the other hand, if the controller unit 201 determines that the sheet to be used for printing is not set (NO in step S908), then in step S909, the controller unit 201 notifies a user to set the sheet in the sheet feeding cassette.

According to the present exemplary embodiment, it is assumed that the controller unit 201 notifies the user to set the sheet determined by the searching in step S905 (or by the sheet determination processing in step S907 if the plurality of types of the sheets is found in step S905) in the sheet feeding cassette. However, the notification in step S909 is not limited thereto. For example, the search range of the sheet set in step S902 or step S903 may be notified to the user.

In a particular notification method, a message may be displayed on the operation unit 111 of the printing apparatus 102 or the display unit 307 of the PC 101 so that the user can set the sheet to be used in printing in the sheet cassette, or sound may be used to notify the user. However, the notification method is not limited thereto.

In step S909, when the controller unit 201 notifies the user to set the sheet to be used for printing in the sheet cassette, the operation returns to step S908 and waits until the user sets the sheet in the sheet cassette.

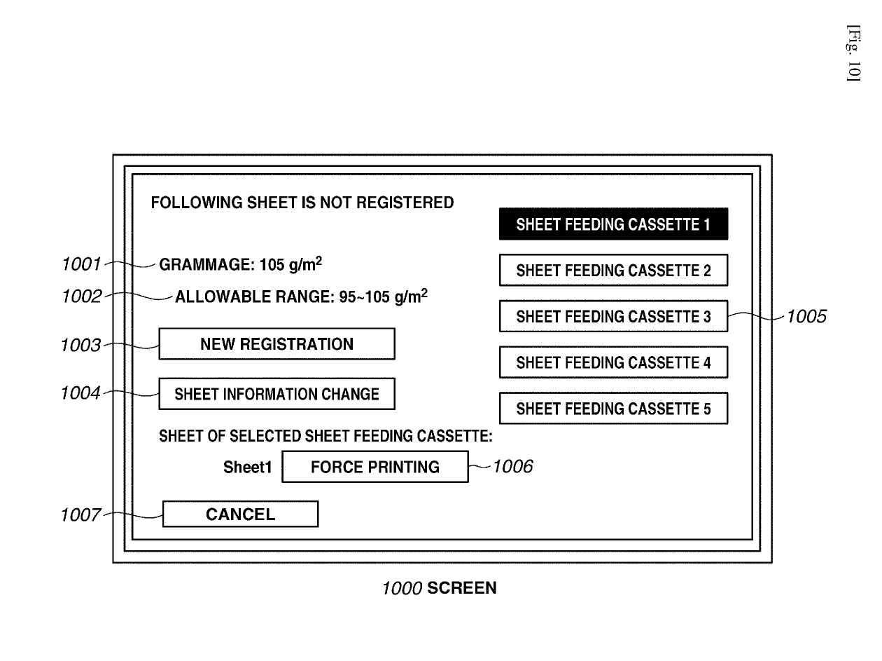

Next, the error processing executed in step S911 is described. FIG. 10 illustrates an example of a screen displayed on the operation unit 111 during the error processing. In a screen 1000 illustrated in FIG. 10, an item 1001 indicates that an attribute value designated in a print job is “grammage 105 g/m²”, and an item 1002 indicates that a search range of a sheet to be used in printing is “grammage 95 to 105 g/m²”. The screen 1000 is displayed when a sheet having a grammage range of 95 to 105 g/m² is not found.

In the error processing in step S911, a user can execute any one of the following four types of processing. Each of the four types of processing is described below.

The first processing is processing for registering new sheet information of a sheet which is included in the search range indicated by the item 1002 in the printing apparatus 102. More particular, a user presses a registration button 1003, and inputs information such as a sheet name and grammage via a registration screen (not illustrated), so that the new sheet information included within the search range indicated by the item 1002 is registered in the sheet management table 400 illustrated in FIG. 4. Accordingly, the printing apparatus 102 executes print processing using the sheet indicated by the newly registered sheet information.

The second processing is processing for changing the sheet information registered in the sheet management table 400. More particularly, a user presses a change button 1004, and changes any of the sheet information pieces registered in the sheet management table 400 via a change screen (not illustrated) such that the sheet information is within the search range indicated by the item 1002. Accordingly, the printing apparatus 102 executes print processing using the sheet indicated by the sheet information changed by the user. According to the second processing, even if the user does not have the sheet included in the search range indicated by the item 1002 at hand, a print job can be executed. The user can select whether the change of the sheet information made by the second processing is temporary until completion of a print job, or is applied to subsequent print jobs.

The third processing is processing for forcibly executing print processing using a sheet set in any of the sheet feeding cassettes of the printing apparatus 102. More particularly, when a user presses a print button 1006 upon selection of any of the sheet feeding cassettes indicated by an item 1005, the printing apparatus 102 executes print processing using the sheet set in the sheet feeding cassette selected by the user. At that time, the sheet selected by the user does not satisfy the attribute value and the allowable range designated in the print job, or a sheet condition for executing sheet processing. However, the instruction made by the user is prioritized in the third processing, and thus the print processing and the sheet processing are forcibly executed. According to the third processing, the user can save the labor of registering and changing sheet information, unlike the first processing and the second processing. Consequently, the third processing can facilitate execution of print processing. Moreover, the print processing and the sheet processing can be forcibly executed as necessary.

The fourth processing is processing for cancelling a print job. When a user presses a cancel button 1007, the print job is cancelled.

According to the above-described present exemplary embodiment, a sheet to be used for printing can be searched in consideration of both an attribute value of a sheet designated in a print job and sheet processing, thus the convenience of users can be enhanced. More particularly, the present exemplary embodiment can prevent an error such that a sheet having an attribute value closest to an attribute value of a sheet designated in a print job is selected as a sheet to be used for printing but the selected sheet cannot be used for the sheet processing.

Moreover, according to the present exemplary embodiment, in a case where a sheet to be used for printing cannot be found in consideration of both an attribute value of a sheet designated in a print job and sheet processing, the four types of error processing can be provided to a user as described in step S911 illustrated in FIG. 9. Thus, the user can select the error processing according to own purpose, and the convenience of users can be enhanced.

Aspects of the present invention can also be realized by a computer of a system or apparatus (or devices such as a CPU or an MPU) that reads out and executes a program recorded on a memory device to perform the functions of the above-described embodiment, and by a method, the steps of which are performed by a computer of a system or apparatus by, for example, reading out and executing a program recorded on a memory device to perform the functions of the above-described embodiment. For this purpose, the program is provided to the computer for example via a network or from a recording medium of various types serving as the memory device (e.g., computer-readable medium).

While the present invention has been described with reference to exemplary embodiments, it is to be understood that the invention is not limited to the disclosed exemplary embodiments. The scope of the following claims is to be accorded the broadest interpretation so as to encompass all modifications, equivalent structures, and functions.

This application claims the benefit of Japanese Patent Application No. 2011-261837, filed Nov. 30, 2011, which is hereby incorporated by reference herein in its entirety.

1. A printing apparatus comprising:
a first storage unit configured to store a plurality of pieces of sheet information indicating a sheet and including an attribute value of the sheet;
a second storage unit configured to store an allowable range used for searching a sheet to be used in print processing using the attribute value;
a third storage unit configured to store a condition of a sheet applicable to sheet processing which is executed with respect to a sheet on which the print processing is executed;
a searching unit configured to search for specific sheet information from the first storage unit based on the allowable range and the condition of the sheet applicable to the sheet processing in a case where an attribute value of a sheet to be used in the print processing and sheet processing are set in a print job; and
a printing unit configured to execute print processing on a sheet indicated by the specific sheet information found by the searching unit.

2. The printing apparatus according to claim 1, further comprising a sheet processing unit configured to execute the sheet processing based on the print job with respect to the sheet on which the print processing is executed.

3. The printing apparatus according to claim 1, wherein, if specific sheet information is not found by the searching unit, the print job is cancelled.

4. The printing apparatus according to claim 1, wherein, if specific sheet information is not found by the searching unit, the print processing and the sheet processing are executed by changing the attribute value stored in the first storage unit.

5. The printing apparatus according to claim 1, wherein, if specific sheet information is not found by the searching unit, the print processing and the sheet processing are executed using a sheet selected by a user.

6. The printing apparatus according to claim 5, wherein, if a sheet selected by a user does not satisfy the allowable range and the condition of the sheet applicable to the sheet processing, the print processing and the sheet processing are executed with use of the sheet.

7. The printing apparatus according to claim 1, wherein the first storage unit stores an attribute value with respect to each of a plurality of attributes.

8. The printing apparatus according to claim 1, wherein the second storage unit stores an allowable range with respect to each of a plurality of attributes.

9. The printing apparatus according to claim 1, wherein the third storage unit stores a condition of a sheet applicable to sheet processing with respect to each of a plurality of types of sheet processing.

10. The printing apparatus according to claim 1, wherein the attribute value is an attribute value of any of a grammage, a size, and a color value parameter.

11. The printing apparatus according to claim 1, wherein the sheet processing is any of folding processing, case binding, punching, and stapling.

12. A printing system comprising:
a first storage unit configured to store a plurality of pieces of sheet information indicating a sheet and including an attribute value of the sheet;
a second storage unit configured to store an allowable range used for searching a sheet to be used in print processing using the attribute value;
a third storage unit configured to store a condition of a sheet applicable to sheet processing which is executed with respect to a sheet on which the print processing is executed;
a searching unit configured to search for specific sheet information from the first storage unit based on the allowable range and the condition of the sheet applicable to the sheet processing in a case where an attribute value of a sheet to be used in the print processing and sheet processing are set in a print job; and
a printing unit configured to execute print processing on a sheet indicated by the specific sheet information searched by the searching unit.

13. A method for controlling a printing apparatus including a first storage unit configured to store a plurality of pieces of sheet information indicating a sheet and including an attribute value of the sheet, a second storage unit configured to store an allowable range used for searching a sheet to be used in print processing using the attribute value, and a third storage unit configured to store a condition of a sheet applicable to sheet processing which is executed with respect to a sheet on which the print processing is executed, the method comprising:
searching for specific sheet information from the first storage unit based on the allowable range and the condition of the sheet applicable to the sheet processing in a case where an attribute value of a sheet to be used in the print processing and sheet processing are set in a print job; and
executing print processing on a sheet indicated by the specific sheet information found by the searching.

14. A non-transitory computer-readable storage medium storing a program for causing a computer to execute a method for controlling a printing apparatus according to claim 13.
